(19) United States
(12) Patent Application Publication
(10) Pub. No.: US 2007/0157590 A1
(43) Pub. Date: Jul. 12, 2007

(54) Touchless harvester

(76) Inventors: Joel Arthur, Chico, CA (US); Ronald C. Borge, Florence, OR (US); Lal S. Singh, Chico, CA (US); Ramesh Varahamurti, Chico, CA (US)

Correspondence Address: Pamela W. Bertani;Weintraub Genshlea Chediak, 11th Floor, 400 Capital Mall, Sacramento, CA, 95814, US

(21) Appl. No.: 11/329,678

(22) Filed: Jan. 10, 2006

(51) Int. Cl. A01D 46/00

(52) U.S. Cl. 56/12.9

(57) ABSTRACT

A touchless harvester employing pulsed air to optimally remove a food product from its host is presented. The touchless harvester includes preferably at least one oscillating impeller housing fitted with an air plenum, a pulse generator and a nozzle to tangentially project pulsed air into a tree canopy or other harvest venue. The touchless harvester is fixedly mounted to a mobile platform to propel the touchless harvester through a harvest venue during operation. The touchless harvester is operated by controlling optimally three tunable variables, which produce optimal displacement conditions for a particular food product. The tunable variables control, respectively, the intensity, the frequency, and the duration that pulsed air is applied to a harvest venue. By tuning the intensity, frequency and duration of the projected air pulse, commensurate with a food product's resonant frequency, the food product experiences fatigue failure at its appendage, and maximum displacement from its host.

### FIELD OF THE INVENTION

The present invention is a touchless harvester employing pulsed air or fluid to displace food product appended from its host by creating maximum displacement conditions without physically engaging the host and causing attendant damage. More specifically, the touchless harvester of the present invention includes preferably at least one oscillating impeller housing and attached pulse generator, and is operated by controlling optimally three tunable variables in relation to the oscillating impeller housing, which results in maximum displacement conditions for the specific food product, optimized efficiency in harvesting operations, and enhanced harvest quality. The tunable variables respectively control the intensity, frequency, and duration at which pulsed air exits each oscillating impeller housing and is applied to a tree canopy or other harvest venue. By applying the appropriate force and frequency of air for an appropriate period of time, the food product experiences fatigue failure at its appendage and consequent removal from its host.

### BACKGROUND OF THE INVENTION

Every object in the universe has its own natural frequency at which it vibrates if excited. If the excitation frequency applied to an object is equivalent to the object's natural frequency, then the object experiences the largest displacement, and is said to be in resonance as a result of realizing its “resonant frequency.” In the context of harvesting conditions, determining and achieving a harvested product's resonant frequency generates fatigue failure at the stem or appendage to which the harvested product is attached, which perfects food product removal, and consequently achieves harvesting.

The intensity and frequency of resonance are a function of a food product's mass, the stiffness of the suspending stem or appendage, as well as the network of branches to which the food product is appended. Thus, the resonant frequency of one food product may significantly differ from that of a neighboring appended food product on the same host. For instance, fruit appending from a particular host may have different masses due to the size and maturity of each appended fruit, such that some pieces of fruit may be large, dry and relatively light in comparison to smaller sizes, which may be hydrated and therefore heavier. Relatively more mature fruit appended from a particular host may have a different mass than another less mature fruit, even though both may appear to be of equivalent size. Such varying conditions also apply to a stem or other appendage, which affects the spring-like support of the appended food product. Moreover, each fruit canopy has its own individual characteristics, including stem and branch flexibility. All of these variables in combination influence a harvest product's resonant frequency, and impact the amount of effort required to attain fatigue failure and remove harvested products from a particular host.

Conventional harvesters commonly employ either traumatic (or blunt) force or shaking to attain resonant frequency and achieve fatigue failure, and fail to account for mass and related differentials in order to optimize harvesting operations. For example, some crops, including fruits and nuts, are commonly harvested via trunk shaker harvesters, which physically grab or otherwise engage the host trunk and shake the host near the resonant frequency of the appended fruits or nuts. Conversely, comb harvesters are used under certain harvesting conditions, and achieve harvesting by brushing a tree canopy with attached combs to disengage the food product and effect harvesting. Both techniques commonly result in scarring the host tree and harvested food product, which may result in significant and irreversible damage to the host, and severely diminish harvest quality.

Conventional harvesters employing air to disengage a food product from its host typically employ an uninterrupted air blast to remove the appended food product. As such air blasts are typically high velocity and uninterrupted, appended food product is exposed to potentially damaging air gusts, which may cause bruising to the food product upon harvesting, and thereby impair harvest quality. U.S. Pat. No. 5,622,036 to Hill demonstrates the limited utility of such a harvester. The disclosed oscillating blower induces air discharge and projects an uninterrupted flow of high velocity air onto or into a tree canopy to, concededly, “create the same shaking action as a tree shaker” by oscillating the blower at a specific frequency. As a result, the invention is geared primarily toward removing residual fruits or nuts from trees, which were not harvested during normal harvesting operations. Such residual fruits or nuts are referred to as “mummies”, and if left unharvested may become infested with worms or other pests, and detrimentally impact the crop of the next growing season. Mummy removal is effectively achieved by the continuous air blast method, particularly since potential damage to mummies as a result of bruising and scarring—and harvest quality at this point—are of little, if any, consequence.

Thus, a need exists for a harvester capable of harvesting food product by creating the phenomenon of maximum displacement at the resonant frequency of the appended food product, which causes fatigue failure at the corresponding appendage, without traumatic force or damage to the host or harvested product.

### SUMMARY OF THE INVENTION

The touchless harvester of the present invention overcomes the functional and operational limitations plaguing conventional harvesters, confounding harvest operations, and impairing harvest quality and yield. To this end, the touchless harvester of the present invention employs a unique pulsed air technology in combination with air flow oscillation, which allows an operator to predetermine the harvest product's resonant frequency, and thereby achieve fatigue failure and product removal efficiently, without physically engaging the host and causing related damage.

The touchless harvester of the present invention is mounted to a mobile platform during harvesting operations and includes preferably at least one oscillating impeller housing, which is fitted with a pulse generator and terminates with a nozzle to direct pulsed air flow. Optimally three “tunable variables” incorporated into the present invention allow an operator to pre-tune and create maximum displacement conditions at the resonant frequency of the harvest product, and thus achieve fatigue failure without physically engaging the host. The intensity, frequency, and durational application of pulsed air exiting the inventive touchless harvester are the primary tunable variables that facilitate operational efficiency and enhanced harvest yield and quality. Air intensity is pre-tuned by adjusting the speed of each oscillating impeller housing according to the present invention. Air frequency is pre-tuned by adjusting the rotational or otherwise alternating speed of each pulse generator according to the present invention. The duration for which pulsed air is applied to a harvest venue is determined by controlling the groundspeed of the mobile platform supporting and transporting the touchless harvester during harvesting operations, and by controlling impeller housing oscillation (i.e., fanning speed).

Conventional engines mounted to the mobile platform drive the speed of the rotating impeller internally disposed within the oscillating impeller housing, and are correspondingly manipulated by an operator-controlled throttle to regulate air intensity. Typically, hydraulic motors or engines control the rotational or otherwise alternating motion of the pulse generator, and are controlled via hydraulic valves or flow control valves to which an operator has access during harvesting operations. Similarly, the oscillatory action of each impeller housing is achieved by way of a hydraulic fanning cylinder, which an operator controls with a fanning cylinder control valve also accessible during harvesting operations. The harvester operator controls pulsed air flow duration by controlling the mobile platform groundspeed as the inventive touchless harvester moves through a harvest venue, and by controlling impeller housing oscillation (i.e., fanning speed).

The touchless harvester of the present invention performs harvesting operations by directing intense, pre-tuned pulsed air toward a tree canopy or other harvest venue. The pre-tuned pulsed air is created in the pulse generator by intermittently interrupting the flow of air prior to exiting the terminal nozzle. Each impeller housing oscillates at a different angle to fan the harvest venue during operations, and the corresponding pulse generators may be out of phase, such that one is fully open while the other is completely closed, to generate high intensity pulsed air flow that will vibrate the canopy or other harvest venue and simultaneously displace the food product alternatively up and down to ultimately achieve fatigue failure and corresponding product removal.

### OBJECTS OF THE INVENTION

It is an object of the present invention to provide a new and novel touchless harvester employing oscillatory pulsed air technology to generate the phenomenon of maximum displacement for a variety of harvest products by tuning the touchless harvester to attain an appended product's resonant frequency, such that the food product experiences fatigue failure at its stem, without the necessity of physically engaging its host.

Viewed from a first vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host.

Viewed from a second vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position.

Viewed from a third vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, and wherein said bending moment instilling means further comprises application of the pulse of fluid at a pretuned frequency level to attain resonant frequency.

Viewed from a fourth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, and wherein said bending moment instilling means further comprises application of the pulse of fluid at a pretuned intensity level to attain resonant frequency.

Viewed from a fifth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, and wherein said bending moment instilling means further embodies the oscillatory application of the pulse of fluid to attain resonant frequency.

Viewed from a sixth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, and wherein said bending moment instilling means further embodies application of the pulse of fluid for a predetermined duration of time to attain resonant frequency.

Viewed from a seventh vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, and wherein said bending moment instilling means further comprises at least one oscillating impeller housing and internally disposed rotating impeller operatively attached to a pulse generator to create and tangentially project the pulse of fluid toward a harvest venue at a pretuned resonant frequency.

Viewed from an eighth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, wherein said bending moment instilling means further comprises at least one oscillating impeller housing and internally disposed rotating impeller operatively attached to a pulse generator to create and tangentially project the pulse of fluid toward a harvest venue at a pretuned resonant frequency, and wherein said bending moment instilling means further comprises a pulse generator containing an internally attached alternating plate that creates and projects the pulse of air tangentially toward the harvest venue.

Viewed from a ninth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, wherein said bending moment instilling means further comprises at least one oscillating impeller housing and internally disposed rotating impeller operatively attached to a pulse generator to create and tangentially project the pulse of fluid toward a harvest venue at a pretuned resonant frequency, wherein said bending moment instilling means further comprises a pulse generator containing an internally attached alternating plate that creates and projects the pulse of air tangentially toward the harvest venue, and wherein said alternating plate is fixedly mounted on a horizontally disposed shaft fitted within said pulse generator, and moves about a horizontal axis.

Viewed from a tenth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, wherein said bending moment instilling means further comprises at least one oscillating impeller housing and internally disposed rotating impeller operatively attached to a pulse generator to create and tangentially project the pulse of fluid toward a harvest venue at a pretuned resonant frequency, wherein said bending moment instilling means further comprises a pulse generator containing an internally attached alternating plate that creates and projects the pulse of air tangentially toward the harvest venue, wherein said alternating plate is fixedly mounted on a horizontally disposed shaft fitted within said pulse generator, and moves about a horizontal axis, and wherein said pulse generator is attached to each of said at least one oscillating impeller housing by an air plenum.

Viewed from an eleventh vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, wherein said bending moment instilling means further comprises at least one oscillating impeller housing and internally disposed rotating impeller operatively attached to a pulse generator to create and tangentially project the pulse of fluid toward a harvest venue at a pretuned resonant frequency, wherein said bending moment instilling means further comprises a pulse generator containing an internally attached alternating plate that creates and projects the pulse of air tangentially toward the harvest venue, wherein said alternating plate is fixedly mounted on a horizontally disposed shaft fitted within said pulse generator, and moves about a horizontal axis, wherein said pulse generator is attached to each of said at least one oscillating impeller housing by an air plenum, and wherein said at least one oscillating impeller housing is individually connected to a fanning means, which oscillates each said at least one oscillating impeller housing about a horizontal axis.

Viewed from a twelfth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, wherein said bending moment instilling means further comprises at least one oscillating impeller housing and internally disposed rotating impeller operatively attached to a pulse generator to create and tangentially project the pulse of fluid toward a harvest venue at a pretuned resonant frequency, wherein said bending moment instilling means further comprises a pulse generator containing an internally attached alternating plate that creates and projects the pulse of air tangentially toward the harvest venue, wherein said alternating plate is fixedly mounted on a horizontally disposed shaft fitted within said pulse generator, and moves about a horizontal axis, wherein said pulse generator is attached to each of said at least one oscillating impeller housing by an air plenum, wherein said at least one oscillating impeller housing is individually connected to a fanning means, which rotates each said at least one oscillating impeller housing about a horizontal axis, and wherein said fanning means comprises a hydraulic cylinder in operative contact with each said at least one oscillating impeller housing to rotate each said at least one oscillating impeller housing about a horizontal axis.

Viewed from a thirteenth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, wherein said bending moment instilling means further comprises at least one oscillating impeller housing and internally disposed rotating impeller operatively attached to a pulse generator to create and tangentially project the pulse of fluid toward a harvest venue at a pretuned resonant frequency, wherein said bending moment instilling means further comprises a pulse generator containing an internally attached alternating plate that creates and projects the pulse of air tangentially toward the harvest venue, wherein said alternating plate is fixedly mounted on a horizontally disposed shaft fitted within said pulse generator, and moves about a horizontal axis, wherein said pulse generator is attached to each of said at least one oscillating impeller housing by an air plenum, wherein said at least one oscillating impeller housing is individually connected to a fanning means, which rotates each said at least one oscillating impeller housing about a horizontal axis, wherein said fanning means comprises a hydraulic cylinder in operative contact with each said at least one oscillating impeller housing to rotate each said at least one oscillating impeller housing about its respective horizontal axis, and wherein each said at least one oscillating impeller housing and each respectively connected said pulse generator are attached to an individual power source means.

Viewed from a fourteenth vantage point, it is an object of the present invention to provide a harvester for removing food product appended from its host which induces fatigue failure in the pendant food product, comprising, in combination, a means to instill a bending moment on the appendage which supports the food product, such that the appendage severs its connection from its host, wherein said bending moment instilling means embodies a pulse of fluid which strikes the food product at an angle causing motion from a first at rest position to a second elevated position, wherein said bending moment instilling means further comprises application of the pulse of fluid at a pretuned frequency level to attain resonant frequency, wherein said bending moment instilling means further comprises application of the pulse of fluid at a pretuned intensity level to attain resonant frequency, wherein said bending moment instilling means further embodies the oscillatory application of the pulse of fluid to attain resonant frequency, wherein said bending moment instilling means further embodies application of the pulse of fluid for a predetermined duration of time to attain resonant frequency, wherein said bending moment instilling means further comprises at least one oscillating impeller housing and internally disposed rotating impeller operatively attached to a pulse generator to create and tangentially project the pulse of fluid toward a harvest venue at a pretuned resonant frequency, wherein said bending moment instilling means further comprises a pulse generator containing an internally attached alternating plate that creates and projects the pulse of air tangentially toward the harvest venue, wherein said alternating plate is fixedly mounted on a horizontally disposed shaft fitted within said pulse generator, and moves about a horizontal axis, wherein said pulse generator is attached to each of said at least one oscillating impeller housing by an air plenum, wherein said at least one oscillating impeller housing is individually connected to a fanning means, which rotates each said at least one oscillating impeller housing about a horizontal axis, wherein said fanning means comprises a hydraulic cylinder in operative contact with each said at least one oscillating impeller housing to rotate each said at least one oscillating impeller housing about a horizontal axis, wherein each said at least one oscillating impeller housing and each connected said pulse generator are attached to an individual power source means, and wherein said harvester and each of the corresponding power source means are fixedly and operatively mounted to a mobile platform for transporting said harvester.

Viewed from a fifteenth vantage point, it is an object of the present invention to provide a harvester employing oscillatory fluid pulsation for removing food product appended from its host which induces fatigue failure in the pendant food product, comprising, in combination: at least one oscillating impeller housing; and a pulse generator operatively attached to each said at least one oscillating impeller housing.

Viewed from a sixteenth vantage point, it is an object of the present invention to provide a harvester employing oscillatory fluid pulsation for removing food product appended from its host which induces fatigue failure in the pendant food product, comprising, in combination: at least one oscillating impeller housing; and a pulse generator operatively attached to each said at least one oscillating impeller housing, wherein each said at least one oscillating impeller housing is operatively attached to a fanning means, which rotates each said at least one oscillating impeller housing about a horizontal axis.

Viewed from a seventeenth vantage point, it is an object of the present invention to provide a harvester employing oscillatory fluid pulsation for removing food product appended from its host which induces fatigue failure in the pendant food product, comprising, in combination: at least one oscillating impeller housing; and a pulse generator operatively attached to each said at least one oscillating impeller housing, wherein each said at least one oscillating impeller housing is operatively attached to a fanning means, which rotates each said at least one oscillating impeller housing about a horizontal axis, and wherein said pulse generator comprises an internally mounted alternating plate, which moves about its horizontal axis to alternately restrict and release air flow.

Viewed from an eighteenth vantage point, it is an object of the present invention to provide a harvester employing oscillatory fluid pulsation for removing food product appended from its host which induces fatigue failure in the pendant food product, comprising, in combination: at least one oscillating impeller housing; and a pulse generator operatively attached to each said at least one oscillating impeller housing, wherein each said at least one oscillating impeller housing is operatively attached to a fanning means, which rotates each said at least one oscillating impeller housing about a horizontal axis, wherein said pulse generator comprises an internally mounted alternating plate, which moves about its horizontal axis to alternately restrict and release air flow, and wherein the alternating speed of said alternating plate is operator controlled by a remotely located valve controller.

Viewed from a nineteenth vantage point, it is an object of the present invention to provide a harvester employing oscillatory fluid pulsation for removing food product appended from its host which induces fatigue failure in the pendant food product, comprising, in combination: at least one oscillating impeller housing; and a pulse generator operatively attached to each said at least one oscillating impeller housing, wherein each said at least one oscillating impeller housing is operatively attached to a fanning means, which rotates each said at least one oscillating impeller housing about a horizontal axis, wherein said pulse generator comprises an internally mounted alternating plate, which moves about its horizontal axis to alternately restrict and release air flow, wherein the alternating speed of said alternating plate is operator controlled by a remotely located valve controller, and wherein the speed of said at least one oscillating impeller housing is operator controlled by a remotely located valve controller.

Viewed from a twentieth vantage point, it is an object of the present invention to provide a harvester employing oscillatory fluid pulsation for removing food product appended from its host which induces fatigue failure in the pendant food product, comprising, in combination: at least one oscillating impeller housing; and a pulse generator operatively attached to each said at least one oscillating impeller housing, wherein each said at least one oscillating impeller housing is operatively attached to a fanning means, which rotates each said at least one oscillating impeller housing about a horizontal axis, wherein said pulse generator comprises an internally mounted alternating plate, which moves about its horizontal axis to alternately restrict and release air flow, wherein the alternating speed of said alternating plate is operator controlled by a remotely located valve controller, wherein the speed of said at least one oscillating impeller housing is operator controlled by a remotely located valve controller, and wherein said harvester is fixedly and operatively mounted to an operator controlled mobile platform to transport said harvester.

Viewed from a twenty-first vantage point, it is an object of the present invention to provide a harvesting method employing oscillatory fluid pulsation for removing food product appended from its host by inducing fatigue failure in the pendant food product, the steps including: tuning the frequency of fluid flow commensurate with the resonant frequency of a particular food product; tuning the intensity of fluid flow commensurate with the resonant frequency of the particular food product; orienting the fluid flow in directional proportion to the food product; and modulating the durational exposure of fluid flow applied to the food product.

Viewed from a twenty-second vantage point, it is an object of the present invention to provide a harvesting method employing oscillatory fluid pulsation for removing food product appended from its host by inducing fatigue failure in the pendant food product, the steps including: tuning the frequency of fluid flow commensurate with the resonant frequency of a particular food product; tuning the intensity of fluid flow commensurate with the resonant frequency of the particular food product; orienting the fluid flow in directional proportion to the food product; and modulating the durational exposure of fluid flow applied to the food product, wherein tuning the frequency of fluid flow involves adjusting a valve controlling fluid flow pulsation.

Viewed from a twenty-third vantage point, it is an object of the present invention to provide a harvesting method employing oscillatory fluid pulsation for removing food product appended from its host by inducing fatigue failure in the pendant food product, the steps including: tuning the frequency of fluid flow commensurate with the resonant frequency of a particular food product; tuning the intensity of fluid flow commensurate with the resonant frequency of the particular food product; orienting the fluid flow in directional proportion to the food product; and modulating the durational exposure of fluid flow applied to the food product, wherein tuning the frequency of fluid flow involves adjusting a valve controlling fluid flow pulsation, and wherein tuning the intensity of fluid flow involves adjusting a throttle controlling fluid flow speed.

Viewed from a twenty-fourth vantage point, it is an object of the present invention to provide a harvesting method employing oscillatory fluid pulsation for removing food product appended from its host by inducing fatigue failure in the pendant food product, the steps including: tuning the frequency of fluid flow commensurate with the resonant frequency of a particular food product; tuning the intensity of fluid flow commensurate with the resonant frequency of the particular food product; orienting the fluid flow in directional proportion to the food product; and modulating the durational exposure of fluid flow applied to the food product, wherein tuning the frequency of fluid flow involves adjusting a valve controlling fluid flow pulsation, wherein tuning the intensity of fluid flow involves adjusting a throttle controlling fluid flow speed, and wherein fluid flow orientation involves directing fluid flow at a range of angles commensurate with the geometry of the food product and its corresponding host.

Viewed from a twenty-fifth vantage point, it is an object of the present invention to provide a harvesting method employing oscillatory fluid pulsation for removing food product appended from its host by inducing fatigue failure in the pendant food product, the steps including: tuning the frequency of fluid flow commensurate with the resonant frequency of a particular food product; tuning the intensity of fluid flow commensurate with the resonant frequency of the particular food product; orienting the fluid flow in directional proportion to the food product; and modulating the durational exposure of fluid flow applied to the food product, wherein tuning the frequency of fluid flow involves adjusting a valve controlling fluid flow pulsation, wherein tuning the intensity of fluid flow involves adjusting a throttle controlling fluid flow speed, wherein fluid flow orientation involves directing fluid flow at a range of angles commensurate with the geometry of the food product and its corresponding host, and wherein modulating the durational exposure of fluid flow involves adjusting the period of time over which fluid flow is directed toward the harvested product and its corresponding host.

### BRIEF DESCRIPTION OF THE DRAWINGS

FIG. 1 is an elevated left front perspective view of the touchless harvester mounted to a mobile platform.

FIG. 2 is a right rear perspective view of the touchless harvester mounted to a mobile platform.

FIG. 3 is a perspective view of a forward oriented oscillating impeller housing.

FIG. 4 is a left side view of a forward oriented oscillating impeller housing at a low point on its horizontal rotational axis.

FIG. 5 is a left side view of a forward oriented oscillating impeller housing at a high point on its horizontal rotational axis.

FIG. 6 is a perspective view of a rear oriented oscillating impeller housing.

FIG. 7 is a back view of a rear oriented oscillating impeller housing at a low point on its horizontal rotational axis.

FIG. 8 is a back view of a rear oriented oscillating impeller housing at a high point on its horizontal rotational axis.

FIGS. 9A, 9B, 10A and 10B depict pulsed air application toward a nut tree and corresponding displacement of the harvested component from its host.

FIGS. 11-14 depict air flow and an alternating plate in a pulse generator, with the alternating plate rotating from an opened to closed position to intermittently restrict and release a pulse of air.

FIGS. 15-18 depict additional embodiments of the pulsed air technology of the present invention with air flow alternately restricted and released by an alternating plate in a pulse generator.

FIG. 19 is an elevated left front perspective view of the touchless harvester with a modified nozzle component. The touchless harvester is mounted to a mobile platform.

### DESCRIPTION OF PREFERRED EMBODIMENTS

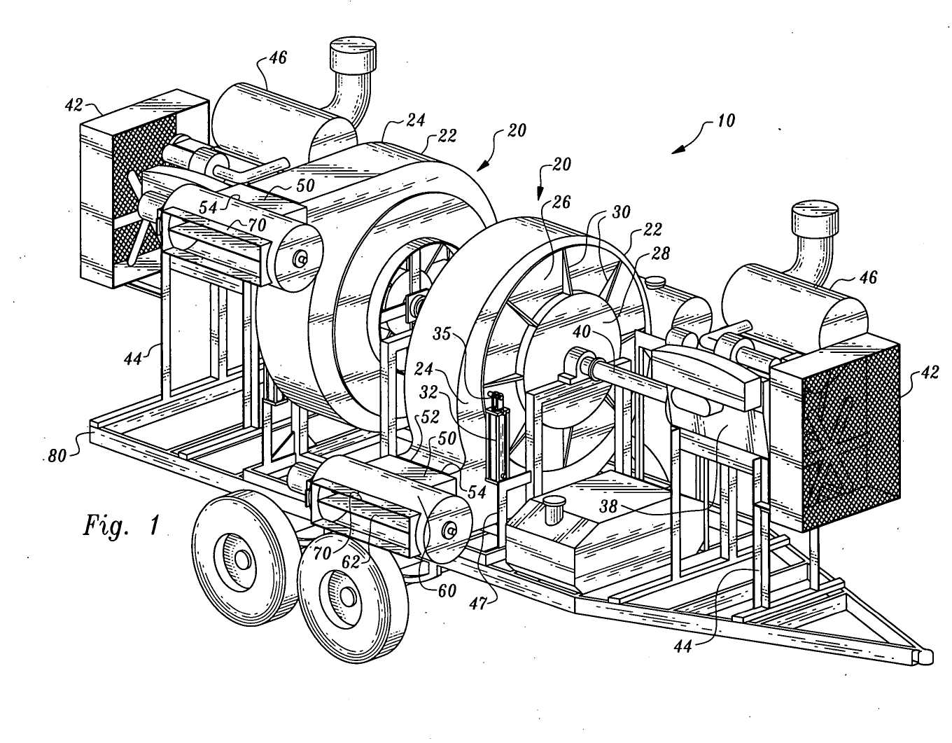

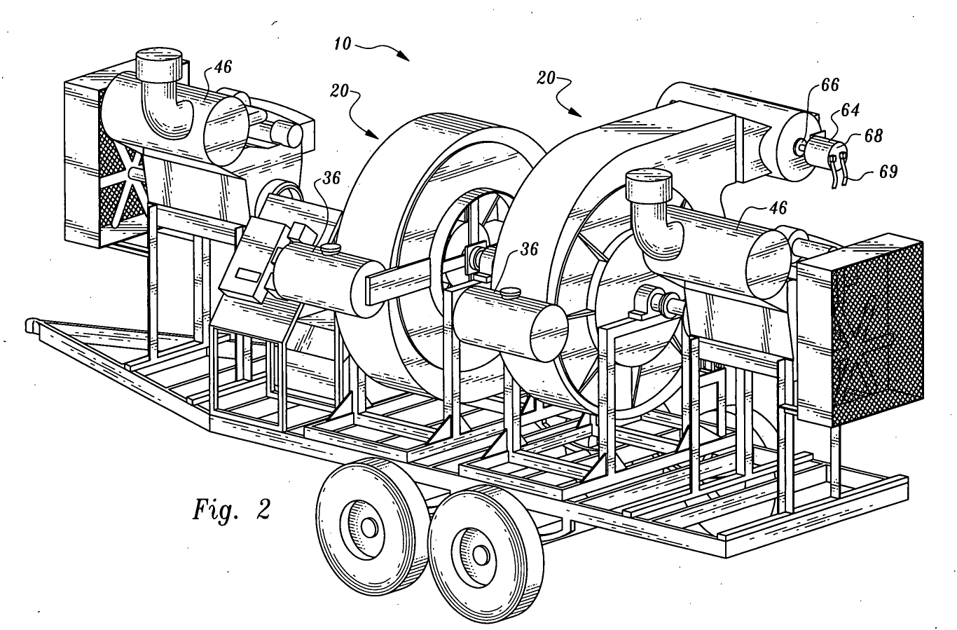

The touchless harvester of the present invention is generally depicted as reference numeral (10) and is illustrated in FIGS. 1 and 2. Touchless harvester (10) is securely mounted atop mobile platform (80) during harvesting operations, and generally comprises at least one oscillating impeller housing (20), fitted with an air plenum (50), a pulse generator (60), an alternating plate (62) within pulse generator (60), and a nozzle (70) or (71), which is adapted into different configurations depending upon the harvested crop. Each oscillating impeller housing (20) is attached to and powered by its own dedicated engine (38), which is also securely mounted to mobile platform (80). Each pulse generator (60) of the present invention is powered by its own dedicated motor unit (not shown), which is likewise securely mounted to mobile platform (80) when touchless harvester (10) is in use. During harvesting operations, an operator drives or otherwise guides mobile platform (80), which supports touchless harvester (10) and its corresponding mounted power units, through rows of trees or other venues to be harvested.

Oscillating impeller housing (20) is cylindrical in shape (22) and has a terminal curvature configuration (24), to which air plenum (50), pulse generator (60) and a nozzle, such as (70) or (71), are terminally attached to collectively define a tangential air discharge pathway perpendicular to mobile platform (80) and directed toward trees or other vegetation within the harvest venue. Centrally located within each oscillating impeller housing (20) is a rotating impeller unit (26) with a plurality of radially projecting propeller blades or spokes (30) circumferentially attached to and extending outwardly from propeller hub (28) and oppositely attached to the internal surface of oscillating impeller housing (20). Propeller hub (28) is mounted to and supported by output drive shaft (40), which is terminally connected to mounted engine (38). Mounted engine (38) is secured to mobile platform (80) by engine support frame (44). Operatively connected to each mounted engine (38) is a radiator with an engine air intake chamber (46), fan, and grilled radiator cover (42) to modulate engine temperature during harvesting operations. Counterbalancing cylinder (36) is fixedly attached to the posterior surface of oscillating impeller housing (20), to stabilize and assist in balancing oscillating impeller housing (20) when in rotational motion about its horizontal axis, as more fully set forth below.

Air plenum (50) includes an air inlet aperture end (52) fixedly attached to the terminal end of terminal curvature section (24) of oscillating impeller housing (20). Air plenum (50) also includes an air outlet aperture end (54), which is fixedly and operatively attached to pulse generator (60). Air generated by rotating impeller unit (26) flows through oscillating impeller housing (20) and terminal curvature section (24), into air inlet aperture end (52) through air plenum (50), and exits air outlet aperture end (54) for delivery into pulse generator (60).

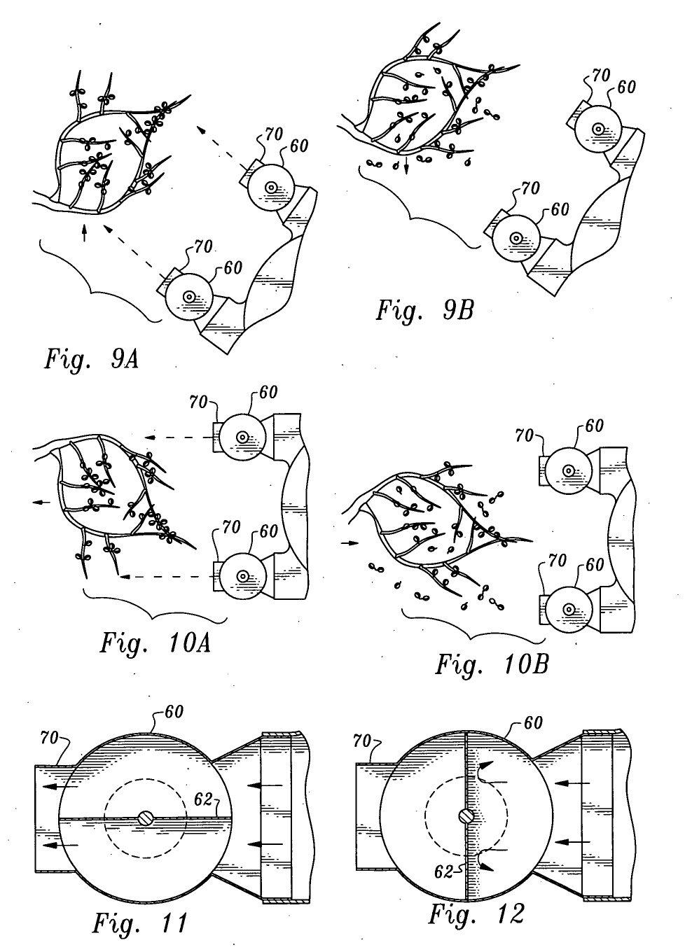

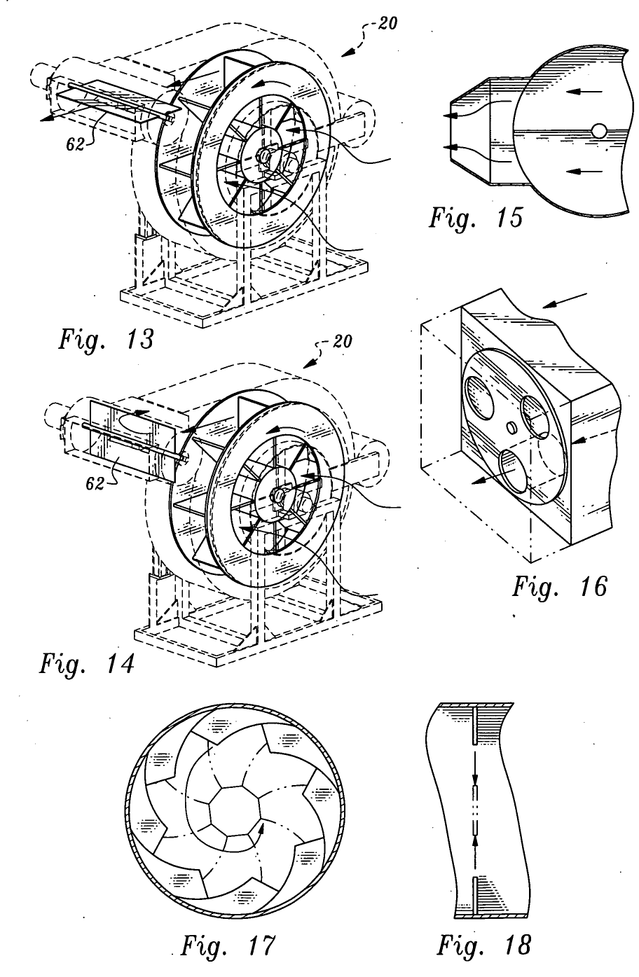

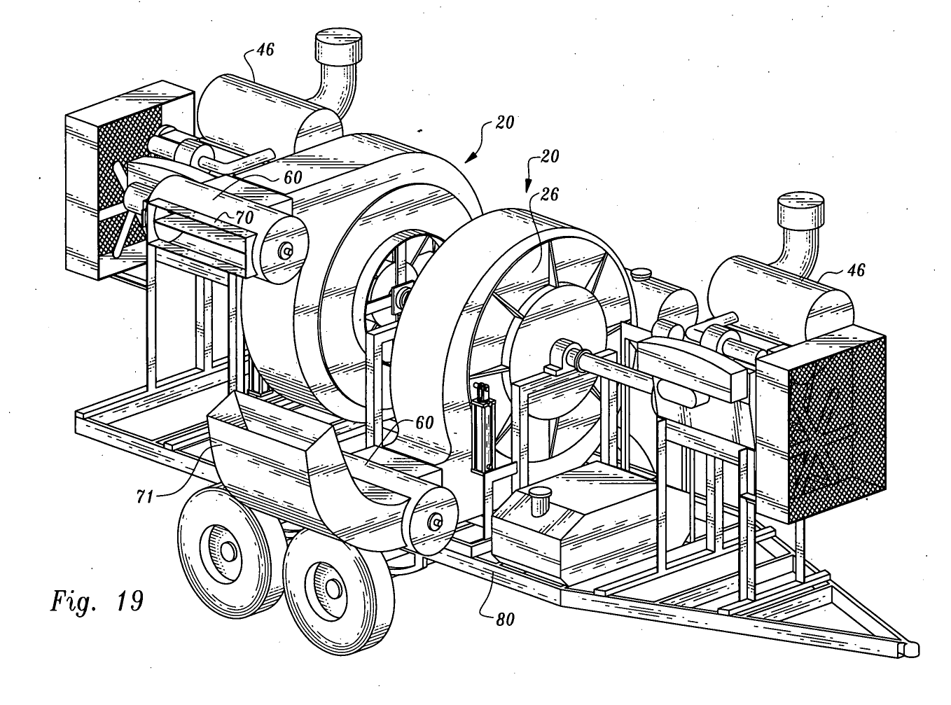

Pulse generator (60) is preferably cylindrical in shape and houses an internally fitted shaft (not shown) upon which alternating plate (62) is fixedly connected. Each pulse generator (60) is attached to its own dedicated power source by a cylindrical connecting rod (64). An extended end (66) of cylindrical connecting rod (64) is positioned within the internally fitted shaft (not shown) housed in pulse generator (60), upon which alternating plate (62) is mounted. Attached to an oppositely disposed power source attachment end (68) of cylindrical connecting rod (64) are fittings (69) which, in operation, are attached to a power source, such as a hydraulic or electrical motor (not shown). When attached to a proper power supply via fittings (69), cylindrical connecting rod (64) is caused to rotate, move in forward and backward alternating positions, or otherwise alternate the internally fitted shaft (not shown) within pulse generator (60) upon which alternating plate (62) is fixedly mounted. The rotational or otherwise alternating motion of the internally fitted shaft in turn causes alternating plate (62) to oscillate or open and close in sharply repetitive motion about its horizontal axis, creating a “flapping” or “pulsing” movement of alternating plate (62), which, as more fully set forth below, results in repetitive pulses of air exiting a nozzle such as (70) or (71). The pulsed air is applied to a tree canopy at a tunable resonant frequency, as depicted in FIGS. 9 and 10, to achieve fatigue failure at the stem of a harvested product and corresponding removal of the harvested product from its host. A nozzle, such as (70) or (71), facilitates increased air velocity and alternating plate (62) facilitates pulsating air flow.

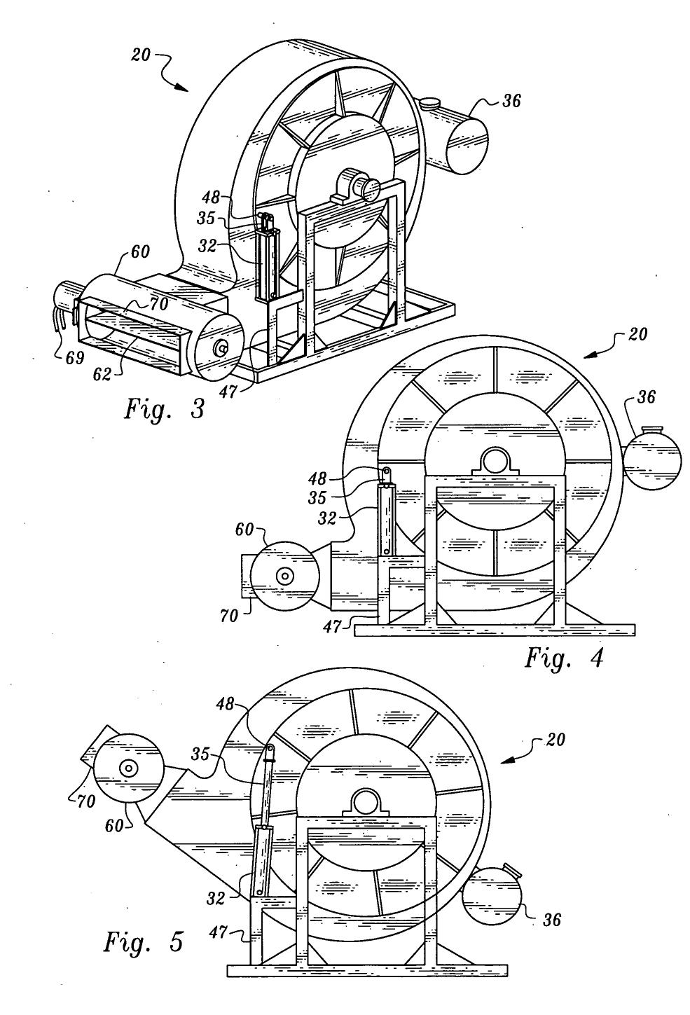

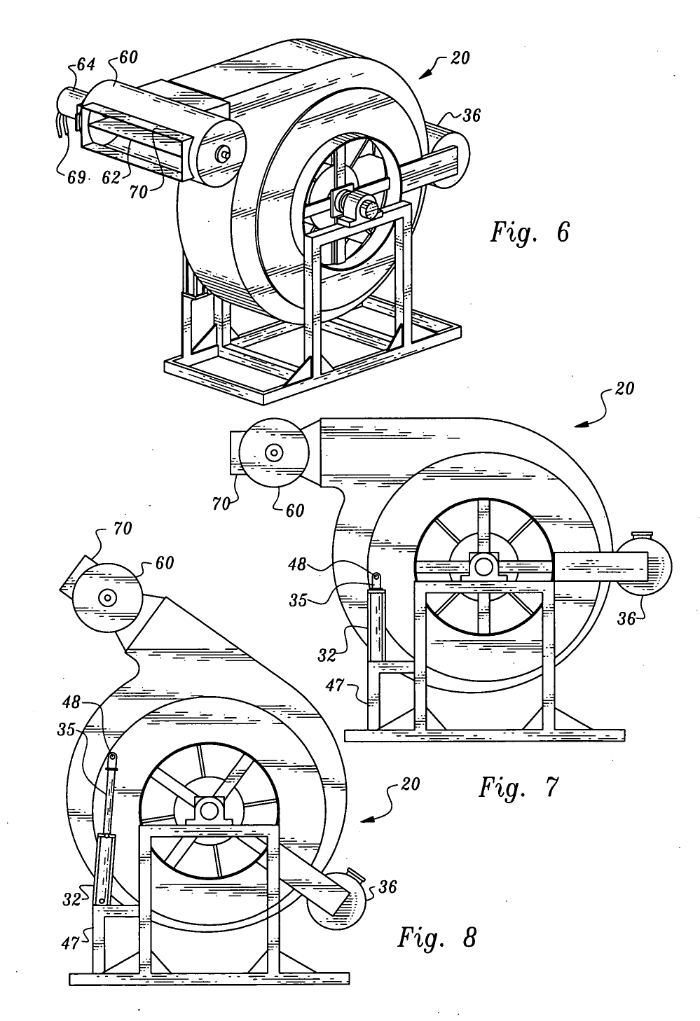

As depicted in FIGS. 3-8, fanning cylinder (32) is respectively attached to oscillating impeller support frame (47) and the outer surface of oscillating impeller housing (20). Vertically disposed and attached within fanning cylinder (32) is a crank rod (35). The upper end of crank rod (35) is fixedly attached to the outer surface of oscillating impeller housing (20) via a laterally extending connecting rod (48) operatively attached to the outer surface of oscillating impeller housing (20). Each fanning cylinder (32) is attached to, and powered by, its own dedicated power source (not shown), such as a conventional hydraulic engine. Power supplied to fanning cylinder (32) causes crank rod (35) to vertically ascend and descend in a sliding fashion within fanning cylinder (32), and correspondingly lift and lower oscillating impeller housing (20). The alternating sliding motion of crank rod (35), and corresponding lifting and lowering of oscillating impeller housing (20) creates a “fanning” motion by which oscillating impeller housing (20) is caused to rotate about its horizontal axis during operation. In order to maximize operational efficiency and harvest yield, each oscillating impeller housing (20) may preferably be oriented to fan simultaneously different areas of a tree canopy or other harvest venue during operation. For instance, one oscillating impeller housing (20) may be oriented to rotate from a horizontal position through 60 degrees, and another oscillating impeller housing (20) may be oriented to rotate from 45 degrees to approximately 90 degrees. In such operative orientation, each oscillating impeller housing (20) simultaneously fans a different area of a tree canopy or other harvest venue with approximately 15 degrees of overlap, which generates turbulence to further fatigue the harvest product at the stem of its host, and further facilitate efficient harvesting operations. Each oscillating impeller housing (20) is fitted with a counterbalancing cylinder fixedly attached to the posterior surface of oscillating impeller housing (20) to optimize oscillatory action and assist in maintaining oscillating impeller housing (20) in balance during harvesting operations.

Touchless harvester (10) is operated by controlling optimally three tunable variables, which ultimately effectuate optimal removal of the harvested product from its host, without attendant damage or related trauma to either the product or its host. The primary tunable variables comprise the intensity, frequency, and duration at which pulsed air from pulse generator (60) will be applied to a host in order to displace the harvested product without touching and correspondingly damaging the host. Controlling the rotational speed of each oscillating impeller housing (20) determines air intensity. Controlling the rotational or otherwise alternating speed of alternating plate (62) within pulse generator (60) determines air frequency. Controlling the groundspeed of mobile platform (80) and the fanning speed of oscillating impeller housing (20) during harvesting operations determines the duration for which pre-tuned pulsed air from pulse generator (60) will be applied to the host.

Variable tuning in this regard ultimately anticipates the mass of the harvest product, the stiffness of the suspending stem attached respectively to the host and the harvested product, and the network of branches to which the harvest product is attached, in order to determine the appropriate resonant frequency range for a particular harvest product. Once an operator determines the resonant frequency range of the harvested product by tuning the fanning speed of oscillating impeller housing (20) and the rotational or otherwise alternating speed of alternating plate (62), an operator may drive, tow, or otherwise guide touchless harvester (10) through a harvest venue at an optimal groundspeed to achieve harvesting. The harvested product is collected on a catch frame (not shown) operatively fitted to and extending outwardly from mobile platform (80).

Mobile platform (80) may be adapted to include an operator platform (not shown) and a control box (not shown), by which an operator controls touchless harvester (10) during harvesting operations. From this operational vantage point, an operator may control the speed of each oscillating impeller housing (20), the fanning motion of each oscillating impeller housing (20), the frequency of pulse generator (60), and the groundspeed of mobile platform (80). Accurately adjusting each of these tunable variables commensurate with the geometry and resonant frequency of the particular food product being harvested maximizes harvesting productivity and yield, while simultaneously eliminating trauma or damage to the harvested tree and tree canopy. More specifically, power sources (not shown) attached respectively to oscillating impeller housing (20) and pulse generator (60) are controlled through flow control valves. The control box includes a pulse generator flow control valve for adjusting the flapping motion of alternating plate (62), and a fanning cylinder flow control valve for adjusting the fanning motion of each oscillating impeller housing (20) as it rotates about its horizontal axis. The operator also controls air velocity for each oscillating impeller (20) by manipulating a throttle (not shown) controlling each individual engine attached to and driving each oscillating impeller housing (20). The operator likewise controls the groundspeed at which mobile platform (80) is driven or otherwise guided through a harvest venue during operation via conventional vehicle acceleration and deceleration mechanisms.

### Functionality Changes

Having thus described the invention, it should be apparent that numerous structural modifications and adaptations may be resorted to without departing from the scope of the instant invention as set forth hereinabove, and as defined below by the claims.

We claim:

1- A harvester for removing food product appended from its host which induces fatigue failure in the pendant food product, comprising, in combination, a means to instill a bending moment on the appendage which supports the food product, such that the appendage severs its connection from its host.

2- The harvester of claim 1 wherein said bending moment instilling means embodies a pulse of fluid which strikes the food product at an angle causing motion from a first at rest position to a second elevated position.

3- The harvester of claim 2 wherein said bending moment instilling means further comprises application of the pulse of fluid at a pretuned frequency level to attain resonant frequency.

4- The harvester of claim 3 wherein said bending moment instilling means further comprises application of the pulse of fluid at a pretuned intensity level to attain resonant frequency.

5- The harvester of claim 4 wherein said bending moment instilling means further embodies the oscillatory application of the pulse of fluid to attain resonant frequency.

6- The harvester of claim 5 wherein said bending moment instilling means further embodies application of the pulse of fluid for a predetermined duration of time to attain resonant frequency.

7- The harvester of claim 6 wherein said bending moment instilling means further comprises at least one oscillating impeller housing operatively attached to a pulse generator to create and tangentially project the pulse of fluid toward a harvest venue at a pretuned resonant frequency.

8- The harvester of claim 7 wherein said bending moment instilling means further comprises a pulse generator containing an internally attached alternating plate that creates and projects the pulse of air tangentially toward the harvest venue.

9- The harvester of claim 8 wherein said alternating plate is fixedly mounted on a horizontally disposed shaft fitted within said pulse generator, and moves about a horizontal axis.

10- The harvester of claim 9 wherein said pulse generator is attached to each of said at least one oscillating impeller housing by an air plenum.

11- The harvester of claim 10 wherein said at least one oscillating impeller housing is individually connected to a fanning means, which rotates each said at least one oscillating impeller housing about a horizontal axis.

12- The harvester of claim 11 wherein said fanning means comprises a hydraulic cylinder in operative contact with each said at least one oscillating impeller housing to rotate each said at least one oscillating impeller housing about a horizontal axis.

13- The harvester of claim 12 wherein each said at least one oscillating impeller housing and connected said pulse generator are attached to an individual power source means.

14- The harvester of claim 13 wherein said harvester and the corresponding power source means are fixedly and operatively mounted to a mobile platform for transporting said harvester.

15- A harvester employing oscillatory fluid pulsation for removing food product appended from its host which induces fatigue failure in the pendant food product, comprising, in combination:
(a) at least one oscillating impeller housing; and
(b) a pulse generator operatively attached to each said at least one oscillating impeller housing.

16- The harvester of claim 15 wherein each said at least one oscillating impeller housing is operatively attached to a fanning means, which rotates each said at least one oscillating impeller housing about a horizontal axis.

17- The harvester of claim 16 wherein said pulse generator comprises an internally mounted alternating plate, which moves about its horizontal axis to alternately restrict and release air flow.

18- The harvester of claim 17 wherein the rotational speed of said alternating plate is operator controlled by a remotely located valve controller.

19- The harvester of claim 18 wherein the speed of said at least one oscillating impeller housing is operator controlled by a remotely located valve controller.

20- The harvester of claim 19 wherein said harvester is fixedly and operatively mounted to an operator controlled mobile platform to transport said harvester.

21- A harvesting method employing oscillatory fluid pulsation for removing food product appended from its host by inducing fatigue failure in the pendant food product, the steps including:
(a) tuning the frequency of fluid flow commensurate with the resonant frequency of a particular food product;
(b) tuning the intensity of fluid flow commensurate with the resonant frequency of the particular food product;
(c) orienting the fluid flow in directional proportion to the food product; and
(d) modulating the durational exposure of fluid flow applied to the food product.

22- The method of claim 21 wherein tuning the frequency of fluid flow involves adjusting a valve controlling fluid flow pulsation.

23- The method of claim 22 wherein tuning the intensity of fluid flow involves adjusting a throttle controlling fluid flow speed.

24- The method of claim 23 wherein fluid flow orientation involves directing fluid flow at a range of angles commensurate with the geometry of the food product and its corresponding host.

25- The method of claim 24 wherein modulating the durational exposure of fluid flow involves adjusting the period of time over which fluid flow is directed toward the harvested product and its corresponding host.
